(19) United States
(12) Patent Application Publication
(10) Pub. No.: US 2026/0321901 A1
(43) Pub. Date: Oct. 15, 2026

(54) BATTERY CELL BUNDLE

(71) Applicant: SK On Co., Ltd., Seoul (KR)

(72) Inventors: Sun Ho JANG, Daejeon (KR); Hyung Ju PAIK, Daejeon (KR); Hae Ryong JEON, Daejeon (KR)

(21) Appl. No.: 19/452,884

(22) Filed: Jan. 20, 2026

(30) Foreign Application Priority Data
Apr. 11, 2025 (KR) 10-2025-0047625

(51) Int. Cl. H01M 50/505; H01M 50/211; H01M 50/367; H01M 50/574

(52) U.S. Cl. CPC H01M 50/505; H01M 50/211; H01M 50/367; H01M 50/574; H01M 2200/10

(57) ABSTRACT

A battery cell bundle is disclosed. According to the present disclosure, there is provided a battery cell bundle comprising a battery cell provided with at least one lead tab, and a busbar assembly fastened to the lead tab, wherein the busbar assembly comprises a busbar having one region provided with a notching portion and electrically connected to the lead tab and a busbar molding accommodates the busbar therein and comprises an opening that exposes the notching portion.

### CROSS-REFERENCE TO RELATED APPLICATION

The present application claims priority to and the benefit of Korean Patent Application No. 10-2025-0047625, filed on Apr. 11, 2025 in the Korean Intellectual Property Office, the entire disclosure of which is incorporated herein by reference.

### TECHNICAL FIELD

An embodiment of the present disclosure relates to a battery cell bundle.

### BACKGROUND

A secondary battery is one type of energy storage means that can be charged and discharged through electrochemical reactions. Secondary batteries are used in various fields using electrical energy. For example, secondary batteries are widely used in the field of mobile devices such as mobile phones, notebooks, and tablets, and broader use is being explored in the field of transportation equipment such as vehicles, aircraft, and ships. In addition, demand for secondary batteries is increasing in the field of energy storage systems (ESSs) for utilizing surplus power.

Secondary batteries can be classified into a cylindrical type, a prismatic type, a pouch type, or the like according to the packaging form. Unlike other packaging forms that use metal can-shaped exterior materials, pouch-type batteries use exterior materials in the form of a thin film, which have relative advantages in weight, energy density, and space utilization. However, depending on the characteristics of the exterior material, pouch-type batteries have a relatively high possibility of rupture in case of external impact or internal short circuits, and

are not capable of dissipating heat easily. In this aspect, a battery type has been proposed in which one or more pouch-type batteries are accommodated inside a metal case.

### SUMMARY

Some embodiments of the present disclosure may provide a battery cell bundle.

In addition, some embodiments of the present disclosure may provide a battery cell bundle in which electrical disconnection of a busbar may be induced by thermal damage.

Further, in some embodiments of the present disclosure, a battery cell bundle may be provided in which a busbar may be properly electrically insulated inside the bundle.

Further, some embodiments of the present disclosure may provide a battery cell bundle capable of properly inducing venting of pressure inside the bundle in response to a thermal runaway situation, or the like.

Further, some embodiments of the present disclosure may provide a battery cell bundle that may improve safety of use.

Some embodiments of the present disclosure may be widely applied in green technology fields such as electric vehicles, battery charging stations, and solar power generation and wind power generation using batteries. In addition, some embodiments of the present disclosure may be used in eco-friendly electric vehicles and hybrid vehicles to suppress air pollution and greenhouse gas emissions and to prevent climate change.

According to one aspect of the present disclosure, a battery cell bundle comprising a battery cell provided with at least one lead tab, and a busbar assembly fastened to the lead tab, wherein the busbar assembly comprises a busbar having one region provided with a notching portion and electrically connected to the lead tab and a busbar molding accommodates the busbar therein and comprises an opening that exposes the notching portion.

In some embodiments, the battery cell bundle may further comprise a case that accommodates the battery cell and the busbar assembly therein, wherein the battery cell may comprises as a pouch-type battery cell in which the lead tab is disposed on at least one end portion in a first direction.

In some embodiments, a plurality of battery cells may be disposed in a second direction, a gap may be provided between sealing portions of a pair of battery cells adjacent in the second direction, and at least a portion of the busbar may be disposed at a position corresponding to the gap.

In some embodiments, the notching portion may comprise at least one notching hole formed to pass through the busbar.

In some embodiments, the notching portion may be provided as a region in which a cross-sectional area of the busbar is formed smaller than a cross-sectional area of an adjacent region.

In some embodiments, the notching portion may be provided such that at least a portion thereof is melted by gas flowing through the opening to electrically disconnect the busbar.

In some embodiments, the busbar may comprise a first part extending in a third direction and coupled to the lead tab, a second part extending from one end of the first part and provided with the notching portion, and a third part extending from one end of the second part in a first direction and electrically connected to an electrode terminal.

In some embodiments, the first part and the second part each may have a width in a second direction, and the width of the first part may be provided such that at least a portion thereof gradually decreases toward the second part.

In some embodiments, the busbar may be insert-molded inside the busbar molding.

In some embodiments, the busbar molding may comprise a first part extending in a third direction and provided with a first access hole that exposes the lead tab, a second part extending from one end of the first part and provided with the opening, and a third part extending from one end of the second part in a first direction and provided with a second access hole that exposes a portion of the busbar for coupling of an electrode terminal.

In some embodiments, the busbar molding may comprise a first part extending in a third direction and provided with a first surface disposed to face an inner surface of a case, and the first surface may provide a first flow path that guides the flow of gas in the third direction between the first surface and the inner surface.

In some embodiments, a first rib extending in the third direction may be provided on the first surface.

In some embodiments, the busbar molding may comprise a third part extending in a first direction and provided with a third surface disposed to face an inner surface of a case, and the third surface may provide a second flow path that guides the flow of gas in the first direction between the third surface and the inner surface.

In some embodiments, a second rib extending in the first direction may be provided on the third surface.

In some embodiments, the battery cell may comprise a folding portion extending in a first direction at one end in a third direction, and the busbar molding may comprise a third part extending in the first direction and pressing the folding portion.

### BRIEF DESCRIPTION OF THE DRAWINGS

The following drawings attached to this specification illustrate embodiments of the present disclosure, and further describe aspects and features of the present disclosure together

with the detailed description of the present disclosure. Thus, the present disclosure should not be construed as being limited to the drawings, in which:

FIG. 1 is a perspective view illustrating a battery cell bundle according to one embodiment of the present disclosure;

FIG. 2 is a perspective view illustrating the battery cell bundle in FIG. 1 with a case removed;

FIG. 3 is a partially enlarged view of the battery cell bundle illustrated in FIG. 2;

FIG. 4 is an exploded perspective view of the battery cell bundle illustrated in FIG. 3;

FIG. 5 is a side view of the battery cell bundle illustrated in FIG. 3;

FIG. 6 is a front view of the battery cell bundle illustrated in FIG. 3;

FIG. 7 is a plan view of the battery cell bundle illustrated in FIG. 3;

FIG. 8 is another embodiment of a notching portion illustrated in FIG. 3;

FIG. 9 is still another embodiment of the notching portion illustrated in FIG. 3;

FIG. 10 is a cross-sectional view of the battery cell bundle illustrated in FIG. 3;

FIG. 11 is a first longitudinal sectional view of the battery cell bundle illustrated in FIG. 3;

FIG. 12 is a second longitudinal sectional view of the battery cell bundle illustrated in FIG. 3;

FIG. 13 is an operational view of the battery cell bundle illustrated in FIG. 1; and

FIG. 14 is a perspective view illustrating a battery cell bundle according to another embodiment of the present disclosure.

### DETAILED DESCRIPTION OF EXEMPLARY EMBODIMENTS

Hereinafter, the present disclosure will be described in detail with reference to the attached drawings. However, these are merely exemplary and the present disclosure is not limited to the specific embodiments described as examples.

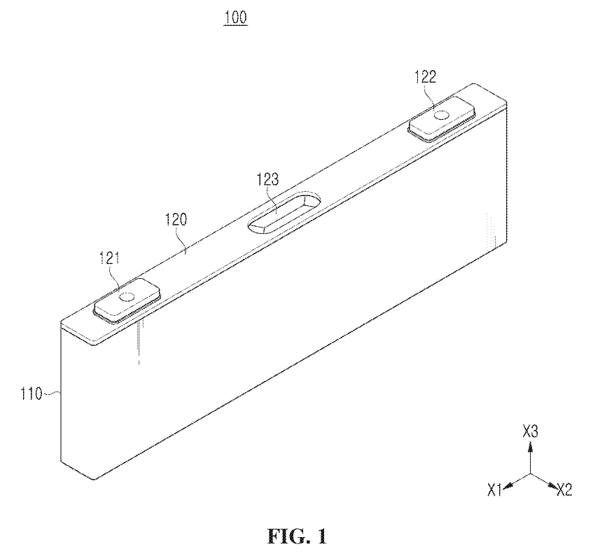

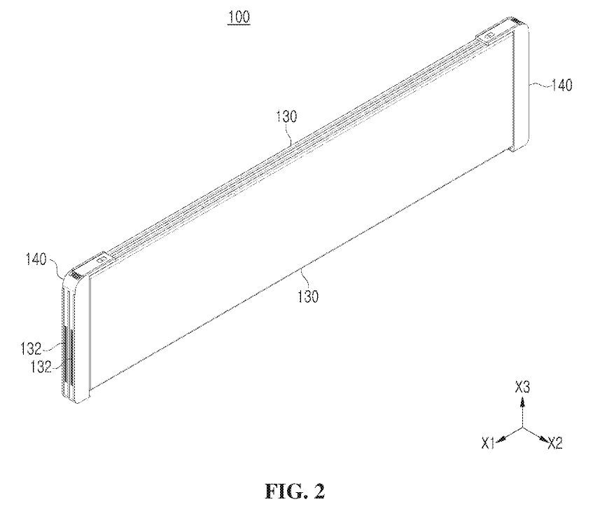

FIG. 1 is a perspective view illustrating a battery cell bundle according to one embodiment of the present disclosure. FIG. 2 is a perspective view illustrating the battery cell bundle in FIG. 1 with a case removed.

For convenience, in the following, a first direction X1 is referred to as a left-right direction, a second direction X2 as a front-rear direction, and a third direction X3 as a vertical direction, based on the coordinate axes illustrated in FIG. 1, and the like.

Referring to FIGS. 1 and 2, in some embodiments, a battery cell bundle (hereinafter referred to as “a bundle 100”) may be provided. The bundle 100 may be provided with one or more battery cells 130 accommodated inside a case 110. In some embodiments, a plurality of battery cells 130 may be provided. For example, as illustrated in FIG. 2, the bundle 100 may be provided with two battery cells 130 accommodated inside the case 110. In some embodiments, the term “the bundle” may be understood to refer to a plurality of battery cells 130 assembled inside the case 110 as a unit. Meanwhile, the number of battery cells 130 constituting the bundle 100 may be increased or decreased as needed, and is not necessarily limited to what is exemplified. For example, the bundle 100 may be provided with a single battery cell 130 or three or more battery cells 130 accommodated inside the case 110. Further, the plurality of battery cells 130 may be provided in various arrangements inside the case 110, such as in the front-rear direction, the left-right direction, or the vertical direction.

In some embodiments, the bundle 100 may comprise the case 110. The case 110 may provide an accommodation space in which the battery cell 130 is accommodated. In the illustrated embodiment, the case 110 is exemplified as a roughly rectangular parallelepiped shaped case, having a long side in the left-right direction and a short side in the vertical direction. However, the shape, dimensions, or the like of the case 110 may be variously modified as needed, and are not necessarily limited to what is exemplified.

In some embodiments, the case 110 may be provided by processing a plate made of a metal material. For example, the case 110 may be made of a metal material such as an aluminum alloy, stainless steel, or the like. The thickness of the case 110 is not particularly limited, but for example, the case 110 made of an aluminum alloy may be provided with a thickness of 0.1 to 0.5 mm, and the case 110 made of stainless steel may be provided with a thickness of 0.05 to 0.3 mm.

In some embodiments, the bundle 100 may comprise a cap plate 120. An upper end of the case 110 may be provided with an opening for insertion of the battery cell 130, and the cap plate 120 may be provided to close such an opening. In some embodiments, at least one of the electrode terminals 121 and 122 may be disposed on the cap plate 120. Specifically, the electrode terminals 121 and 122 may comprise a first electrode terminal 121 that functions as a positive or negative electrode terminal and a second electrode terminal 122 that functions as a corresponding negative or positive electrode terminal, and at least one of the first and second electrode terminals 121 and 122 may be disposed on the cap plate 120. For example, as illustrated in FIG. 1, the first and second electrode terminals 121 and 122 may be horizontally spaced apart from each other on an upper surface of the cap plate 120.

Additionally, in some embodiments, the cap plate 120 may be provided with a vent 123. The vent 123 may be provided to open in response to a pressure inside the case 110. For example, the vent 123 may be provided as a notch configured to break when a pressure above a set pressure is applied, or as a valve provided to open when a pressure above a set pressure is applied. In some embodiments, the vent 123 may be disposed between the first and second electrode terminals 121 and 122. In the illustrated embodiment, the first and second electrode terminals 121 and 122 are horizontally spaced apart on the cap plate 120, and the vent 123 is disposed in the center of the first and second electrode terminals 121 and 122. This arrangement of the vent 123 is also related to the direction of gas flow by a busbar assembly 140, which will be described below.

Meanwhile, in some embodiments, the bundle 100 may comprise one or more battery cells 130. As described above, a plurality of battery cells 130 may be provided, and the illustrated embodiment exemplifies two battery cells 130. In the illustrated embodiment, the two battery cells 130 may be disposed with front and rear surfaces thereof facing each other.

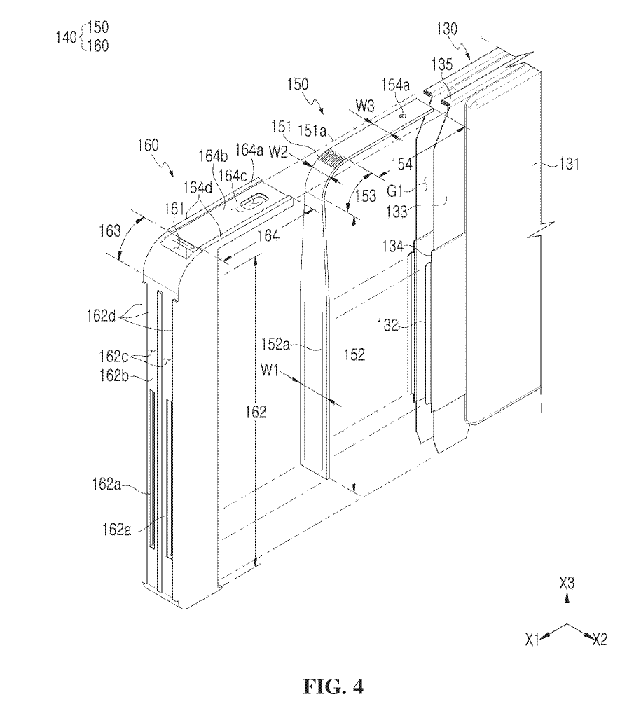

In some embodiments, the battery cell 130 may be provided as a pouch-type battery cell. In other words, the battery cell 130 may be provided with an electrode assembly packaged in an exterior material 131 (see FIG. 4) in the form of a flexible film. Further, in some embodiments, the battery cell 130 may be provided with a lead tab 132 at at least one end portion in the first direction X1. For example, as illustrated in FIG. 2, the battery cell 130 may be provided with one lead tab 132 at a left end portion and another lead tab 132 at a right end portion. For reference, in FIG. 2, only the lead tab 132 provided on the left side of the end portion of the battery cell 130 is illustrated according to the direction of the view. A plurality of sets of lead tabs 132 may be provided depending on the number of battery cells 130. For example, when two battery cells 130 are provided, as illustrated in FIG. 2, one side (left or right) end portion of the bundle 100 may be provided with two lead tabs 132 extending from each battery cell 130.

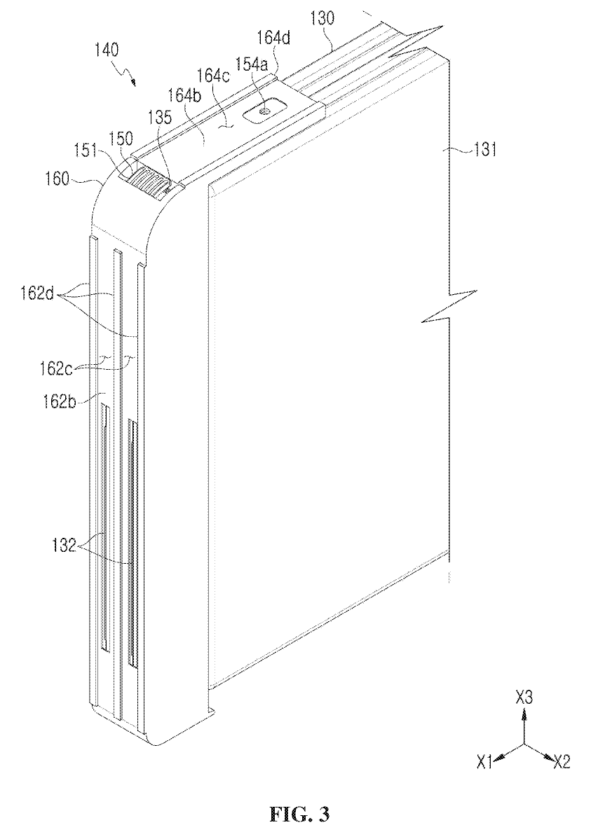

Meanwhile, in some embodiments, the bundle 100 may comprise the busbar assembly 140. The busbar assembly 140 may be fastened between the lead tab 132 and the electrode terminals 121 and 122. Thereby, the busbar assembly 140 may make an electrical connection between the lead tab 132 and the electrode terminals 121 and 122. The detailed configuration of the busbar assembly 140 will be described below with reference to FIG. 3.

In some embodiments, a plurality of busbar assemblies 140 may be provided to correspond to each of the electrode terminals 121 and 122. In the illustrated embodiment, the busbar assembly 140 is exemplified as two busbar assemblies. In the illustrated embodiment, a single busbar assembly 140 disposed on the left side may be fastened to the lead tab 132 provided on the left side of each battery cell 130 to electrically connect with the first electrode terminal 121. Additionally, the other busbar assembly 140 disposed on the right side may be fastened to the lead tab provided on the right side of each battery cell 130 to electrically connect with the second electrode terminal 122.

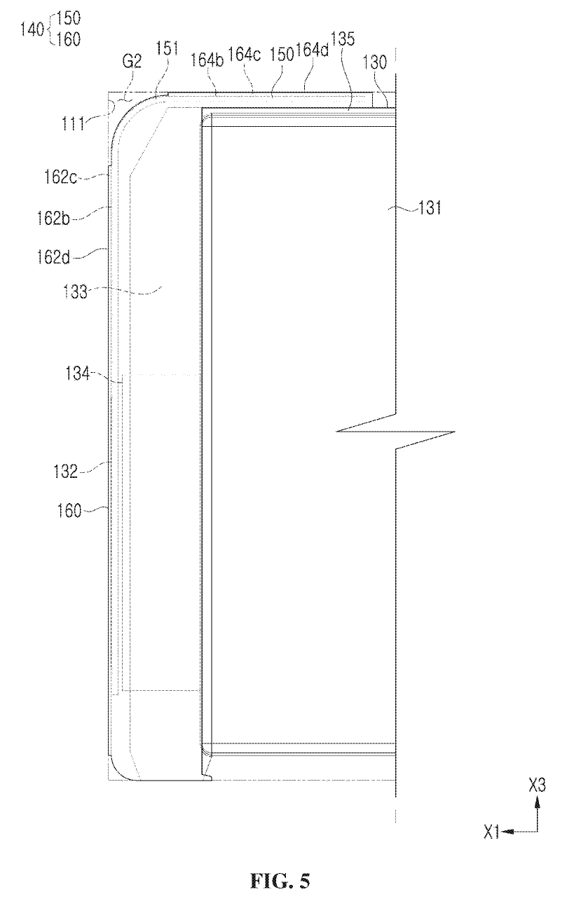

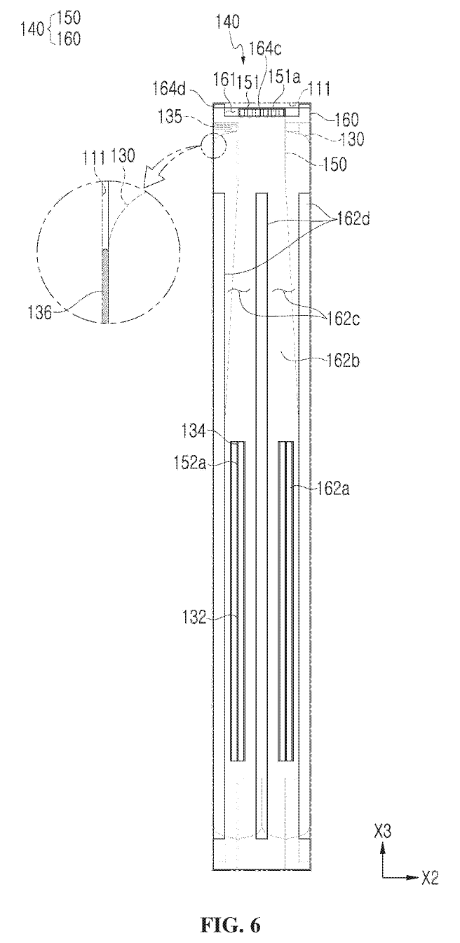

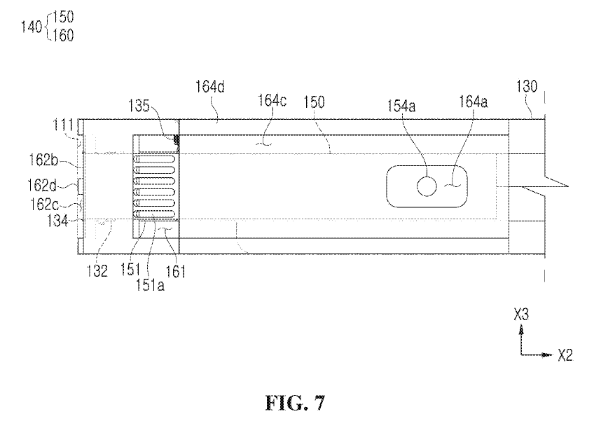

FIG. 3 is a partially enlarged view of the battery cell bundle illustrated in FIG. 2. FIG. 4 is an exploded perspective view of the battery cell bundle illustrated in FIG. 3. FIG. 5 is a side view of the battery cell bundle illustrated in FIG. 3. FIG. 6 is a front view of the battery cell bundle illustrated in FIG. 3. FIG. 7 is a plan view of the battery cell bundle illustrated in FIG. 3.

Referring to FIGS. 3-7, in some embodiments, the bundle 100 may comprise the battery cell 130 provided with at least one lead tab 132 and the busbar assembly 140 fastened to the lead tab 132. Here, the busbar assembly 140 may comprise a busbar 150 having one region provided with a notching portion 151 and electrically connected to the lead tab 132 and a busbar molding 160 provided with an opening 161 that accommodates the busbar 150 therein and exposes the notching portion 151.

Specifically, the bundle 100 may comprise the battery cell 130. As described above, the battery cell 130 may be provided as a pouch-type battery cell 130. In addition, the battery cell 130 may be provided with an exterior material 131 in the form of a flexible film that accommodates the electrode assembly therein, and the exterior material 131 may be provided with a sealing portion 133 along an edge thereof to seal the interior in which the electrode assembly is disposed from the outside. The sealing portion 133 may be provided along the entire edge of the exterior material 131, or may be provided along a portion of the edge of the exterior material 131. For example, the exterior material 131 may be provided as two sheet members with the entire edge bonded through the sealing portion 133, or may be provided as one sheet member such that the remaining edges except for one side (lower end) edge are bonded.

Additionally, in some embodiments, the battery cell 130 may comprise the lead tab 132. In the illustrated embodiment, the lead tab 132 is disposed at a left end portion of the battery cell 130. The lead tab 132 may be electrically connected to the electrode assembly accommodated in the exterior material 131, thereby providing an electrical connection path to the exterior of the battery cell 130. Accordingly, the lead tab 132 may be disposed so that at least a portion is exposed outside the exterior material 131. In the illustrated embodiment, a left end region of the lead tab 132 is partially exposed outside the exterior material 131. An insulating portion 134 may be provided between the lead tab 132 and the sealing portion 133. The insulating portion 134 may function to electrically insulate the lead tab 132 from the sealing portion 133.

Meanwhile, in some embodiments, the battery cell 130 may comprise a folding portion 135. The folding portion 135 may be provided with the sealing portion 133 partially folded along an upper end edge of the battery cell 130. In other words, the folding portion 135 may be provided with the sealing portion 133 disposed at an upper end edge portion of the battery cell 130 and folded one or more times along a folding line extending in the left-right direction. The folding portion 135 may be provided to extend to the left and right along the upper end edge of the battery cell 130.

In some embodiments, the folding portion 135 as described above may function to limit the position at which gas is discharged from the battery cell 130. In other words, the folding portion 135 may be formed to withstand relatively high pressures due to the folded structure of the sealing portion 133, and thus the pressure inside the battery cell 130 may be guided to be discharged through a region in which the lead tab 132 is disposed. The region in which the lead tab 132 is disposed may have a relatively weak bonding strength compared to other regions of the sealing portion 133 due to the thickness of the lead tab 132, the presence of the insulating portion 134, and the like. Accordingly, the pressure inside the battery cell 130 may be induced to break the bond of the sealing portion 133 in the region in which the lead tab 132 is disposed and discharge to the outside of the battery cell 130.

Meanwhile, in some embodiments, the plurality of battery cells 130 may be provided, and the plurality of battery cells 130 may be disposed in the front-rear direction such that front and rear surfaces face each other. In addition, a predetermined gap G1 may be provided between the sealing portions 133 of a pair of battery cells 130 adjacent in the front-rear direction. More specifically, as illustrated in FIG. 4, the sealing portion 133 of each of the battery cells 130 may be provided with a relatively thin thickness relative to other regions in which the electrode assembly is disposed. Accordingly, the predetermined gap G1 may be formed between the sealing portions 133 of adjacent battery cells 130. The gap G1 may extend vertically between adjacent battery cells 130.

In some embodiments, at least a portion of the busbar 150 may be disposed at a position corresponding to the gap G1 as described above. For example, the busbar 150 may be disposed in the center of the gap G1 in the left-right direction as described above. This arrangement allows gas discharged from the battery cell 130 to flow through the gap G1 with an appropriate flow space toward the opening 161, which will be described below. In other words, gas leaking from the region around the lead tab 132 may collect inside the gap G1 and flow toward the opening 161, thereby inducing effective disconnection of the notching portion 151.

Meanwhile, as illustrated in FIG. 6, in some embodiments, the battery cell 130 may be at least partially adhered to an inner surface 111 of the case 110 through an adhesive member 136. Accordingly, the battery cell 130 may be more stably secured inside the case 110. In some embodiments, the adhesive member 136 may comprise a heat dissipation material. The adhesive member 136 may function to facilitate heat dissipation from the battery cell 130 to the case 110. Although not particularly limited, for example, the adhesive member 136 may be provided as a hot melt adhesive, an inorganic adhesive, or the like, and may be provided with a thickness of 0.1 mm or less.

Meanwhile, in some embodiments, the bundle 100 may comprise the busbar assembly 140, and the busbar assembly 140 may comprise the busbar 150 and the busbar molding 160. The busbar 150 may be disposed substantially inside the busbar molding 160, except for partial regions such as the notching portion 151. In some embodiments, the busbar 150 may be provided by being insert-molded inside the busbar molding 160. In such cases, the busbar assembly 140 may be provided as a single assembled part that incorporates the busbar 150 and the busbar molding 160.

The busbar 150 may be formed of an electrically conductive material. For example, the busbar 150 may be formed of a metal material such as aluminum, copper, or the like. The busbar 150 may be electrically connected to the lead tab 132 provided on the battery cell 130, thereby providing an electrical connection path from the battery cell 130 to the electrode terminal 121.

In some embodiments, the notching portion 151 may be provided in one region of the busbar 150. In the illustrated embodiment, the notching portion 151 is disposed in a bending region of the busbar 150. The notching portion 151 may be provided such that disconnection is induced by high-temperature gas flowing into the region. In other words, the notching portion 151 may be provided such that the melting is induced by a gas-mediated thermal factor, thereby electrically disconnecting the busbar 150. However, in the present disclosure, disconnection of the notching portion 151 due to an overcurrent is not completely excluded. In some operational examples, the notching portion 151 may function to induce disconnection by one or more of a high-temperature gas or overcurrent.

The notching portion 151 may be provided in various forms as long as it is capable of inducing proper disconnection of the busbar 150 in the corresponding region. In some embodiments, the notching portion 151 may comprise at least one notching hole 151a formed to pass through the busbar 150. Specifically, as illustrated in FIG. 4, the notching portion 151 may be provided with one or more notching holes 151a. In the illustrated embodiment, the notching hole 151a is exemplified in the form of a slit hole extending in a longitudinal direction of the busbar 150, and a plurality of notching holes are disposed in parallel along a width direction of the busbar 150. However, the shape, number, arrangement, etc., of the notching holes 151a are not necessarily limited to those exemplified.

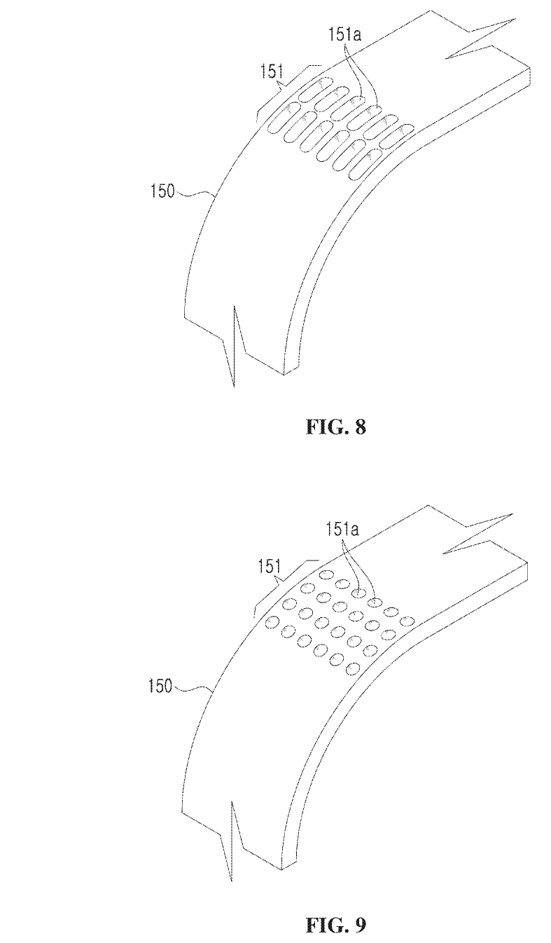

FIG. 8 is another embodiment of the notching portion illustrated in FIG. 3. FIG. 9 is still another embodiment of the notching portion illustrated in FIG. 3.

The embodiment illustrated in FIG. 8 exemplifies notching holes 151a in which a plurality of slit holes of a smaller size compared to the embodiment illustrated in FIG. 4 and the like are disposed. Further, the embodiment illustrated in FIG. 9 exemplifies a notching hole 151a provided as a circular hole rather than a slit hole. In the embodiment illustrated in FIG. 9, a plurality of notching holes 151a provided as circular holes may be distributed across the entire region of the notching portion 151.

Referring again to FIGS. 3-7, in some embodiments, the notching portion 151 may be provided as a region in which a cross-sectional area of the busbar 150 is formed smaller than a cross-sectional area of an adjacent region. For example, the notching portion 151 may be provided with a plurality of notching holes 151a, and the notching holes 151a may cause the notching portion 151 to be formed with a relatively small cross-sectional area compared to other adjacent regions. Alternatively, the busbar 150 may be formed with a different width, thickness, or the like in the region corresponding to the notching portion 151, and thus the notching portion 151 may be formed with a relatively smaller cross-sectional area compared to other adjacent regions. Although not illustrated, for example, the busbar 150 may be provided to have a relatively small width in the region corresponding to the notching portion 151, and thus the notching portion 151 may be formed with a relatively small cross-sectional area compared to other adjacent regions. The notching portion 151 may function to induce disconnection by one or more of a high-temperature gas or overcurrent.

Meanwhile, in some embodiments, the busbar 150 may comprise first to third parts 152, 153, and 154 in a longitudinal direction. The first to third parts 152, 153, and 154 may be provided as partial regions of the busbar 150 in the longitudinal direction.

Specifically, with reference to the illustrated embodiment, the first part 152 may have a predetermined width W1 and may be formed to extend in the vertical direction. Further, the first part 152 may be coupled to the lead tab 132. Thereby, the busbar 150 may be electrically connected to the battery cell 130. In some embodiments, the first part 152 may be provided with a lead-tab fastening hole 152a to which the lead tab 132 is coupled. In the illustrated embodiment, the lead-tab fastening hole 152a is provided in the form of a slit hole vertically extending according to the shape, arrangement direction, etc., of the lead tab 132. Further, to correspond to the two lead tabs 132 disposed in the front-rear direction, in the first part 152, two lead-tab fastening holes 152a are disposed in parallel. For proper engagement with the lead tab 132, the lead-tab fastening hole 152a may be provided to be exposed to the outside of the busbar molding 160, which will be described below.

Meanwhile, the second part 153 may be formed to extend from an upper end of the first part 152. In the illustrated embodiment, the second part 153 is provided as a bent region of the busbar 150 to connect the first part 152, which extends in the vertical direction, and the third part 154, which extends in the left-right direction. The second part 153 may be provided with the notching portion 151 described above. As will be described below, the notching portion 151 may be provided to be exposed to the outside of the busbar molding 160 to properly interfere with gases or the like inside the bundle 100.

In the above, the second part 153 may be disposed with an appropriate gap G2 from the inner surface 111 of the case 110. Specifically, as illustrated in FIG. 5, the second part 153 may be disposed to have a predetermined gap G2 from the inner surface 111 of the case 110 at a corner portion of the case 110 because of its bent shape. The gap G2 may function to provide a flow space for gas through the notching portion 151.

Meanwhile, the third part 154 may be formed to extend from an upper end of the second part 153 toward the folding portion 135 of the upper end of the battery cell 130. In the illustrated embodiment, the third part 154 is formed to extend a predetermined length to the right from the upper end of the second part 153 toward the folding portion 135. The third part 154 may be electrically connected to the electrode terminal 121. For example, as illustrated in FIG. 7, the third part 154 may be provided with a terminal coupling hole 154a, and the first electrode terminal 121 may be electrically connected to the third part 154 or the busbar 150 through a coupling member coupled to the terminal coupling hole 154a.

Meanwhile, in some embodiments, the busbar 150 may have predetermined widths W1, W2, and W3. For reference, in the illustrated embodiment, the widths W1, W2, and W3 of the busbar 150 refer to the widths W1, W2, and W3 in the front-rear direction (i.e., the second direction X2). Here, the widths W1, W2, and W3 of the busbar 150 may vary depending on the position in the longitudinal direction of the busbar 150. In other words, the busbar 150 may have different widths W1, W2, and W3 depending on its position in the longitudinal direction.

Specifically, the first part 152 and the second part 153 may be provided with the predetermined widths W1 and W2, respectively, in the front-rear direction. Here, the width W1 of the first part 152 may be provided such that at least a portion thereof gradually decreases toward the second part 153. For example, the first part 152 may be provided such that a lower region has the predetermined width W1 as illustrated, and the width W1 may gradually decrease from a middle region toward an upper end region. In addition, the second part 153 may have the width W2 corresponding to the upper end region of the first part 152, and thus may have the width W2 that is relatively smaller than the lower region of the first part 152. Such a shape of the busbar 150 may contribute to properly inducing disconnection in the notching portion 151 by reducing the cross-sectional area of the busbar 150 in the second part 153.

Meanwhile, the busbar molding 160 may be provided to accommodate the busbar 150, as described above. Here, the busbar molding 160 may be provided with the opening 161 that exposes the notching portion 151. In other words, the busbar 150 may be disposed inside the busbar molding 160 such that the notching portion 151 is exposed by the opening 161. Accordingly, the busbar 150 is disposed inside the busbar molding 160 to be electrically insulated from other components within the bundle 100, while still being able to properly interfere with heat, gases, and the like inside the bundle 100 through the opening 161 that is exposed to the outside of the busbar molding 160. In some embodiments, the opening 161 may be implemented by properly limiting the resin injection region during insert molding of the busbar molding 160 over the busbar 150.

In some embodiments, the busbar molding 160 may be provided as an electrically insulating material. For example, the busbar molding 160 may comprise a material such as modified polyphenylene oxide (MPPO), polypropylene (PP), polycarbonate (PC), polyamide (PA), and the like.

Similar to the above-described busbar 150, in some embodiments, the busbar molding 160 may comprise first to third parts 162, 163, and 164 in a longitudinal direction. The first to third parts 162, 163, and 164 may be provided as partial regions of the busbar molding 160 in the longitudinal direction. Further, the first to third parts 162, 163, and 164 of the busbar molding 160 may be provided to correspond to the first to third parts 152, 153, and 154 of the above-described busbar 150.

Specifically, with reference to the illustrated embodiment, the first part 162 may be formed to extend in the vertical direction. In addition, the first part 162 may be provided with a first access hole 162a that exposes the lead tab 132 of the battery cell 130. In the illustrated embodiment, the first access hole 162a is provided in the form of a slit hole vertically extending according to the shape, arrangement direction, etc., of the lead tab 132. However, the first access hole 162a is intended to guide gas leaking from the region around the lead tab 132 to a first flow path 162c, which will be described below, and is not necessarily required to be provided in a form that fits tightly to the lead tab 132. For example, the first access hole 162a may be provided as a slit hole that is slightly greater than the lead tab 132.

In some embodiments, the first part 162 may be provided with a side surface 162b that is disposed to face the inner surface 111 of the case 110. Specifically, the first part 162 may have the left side surface 162b as illustrated in FIG. 4, and the side surface 162b may be disposed to face the inner surface 111 of the case 110 as illustrated in FIG. 5. Here, the side surface 162b of the first part 162 may be disposed spaced apart from the inner surface 111 of the case 110 by a predetermined gap. Accordingly, the first flow path 162c may be provided between the side surface 162b of the first part 162 and the inner surface 111 of the case 110.

The first flow path 162c may extend vertically between the side surface 162b of the first part 162 and the inner surface 111 of the case 110, depending on the shape in which the first part 162 extends.

As described above, the first flow path 162c may function to guide the flow of gas discharged from the battery cell 130 toward the upper side. Specifically, when gas leaks from the region around the lead tab 132 of the battery cell 130, the leaked gas may enter the first flow path 162c through the first access hole 162a, and the gas that has entered may be guided toward the upper side along the first flow path 162c between the inner surface 111 of the case 110 and the side surface 162b of the first part 162.

In some embodiments, the side surface 162b of the first part 162 may be provided with a first rib 162d. The first rib 162d may be provided to extend vertically along the side surface 162b of the first part 162. In some embodiments, a plurality of first ribs 162d may be provided depending on the number and arrangement of the first access holes 162a. For example, in the illustrated embodiment, three first ribs 162d are disposed at predetermined gaps in the front-rear direction, and two first access holes 162a are disposed between a pair of first ribs 162d that are adjacent in the front-rear direction. Furthermore, the first flow path 162c is partitioned into two regions by the first rib 162d. The first rib 162d may function to more reliably secure the first flow path 162c between the inner surface 111 of the case 110 and the side surface 162b of the first part 162 and to induce smoother gas flow.

Meanwhile, the second part 163 may be formed to extend from an upper end of the first part 162. In the illustrated embodiment, the second part 163 is formed to extend with a gentle curved shape to correspond to the second part 153 of the above-described busbar 150. Further, the second part 163 may be provided with the opening 161. The opening 161 may be provided in a form in which the busbar molding 160 is partially removed in the corresponding region. Further, the opening 161 may be disposed to correspond to the notching portion 151 of the busbar 150. Accordingly, the notching portion 151 may be exposed to the outside of the busbar molding 160 through the opening 161.

In addition, the third part 164 may be formed to extend from an upper end of the second part 163 in the left-right direction. Specifically, in the illustrated embodiment, the third part 164 extends in the left-right direction by a predetermined length to the right from the upper end of the second part 163 toward the folding portion 135 of the upper end of the battery cell 130. In some embodiments, the third part 164 may be provided with a second access hole 164a. The second access hole 164a may function to expose a portion of the busbar 150 for the coupling of the electrode terminal 121. In the illustrated embodiment, the second access hole 164a is disposed to correspond to the terminal coupling hole 154a provided in the busbar 150 and provided to expose the terminal coupling hole 154a.

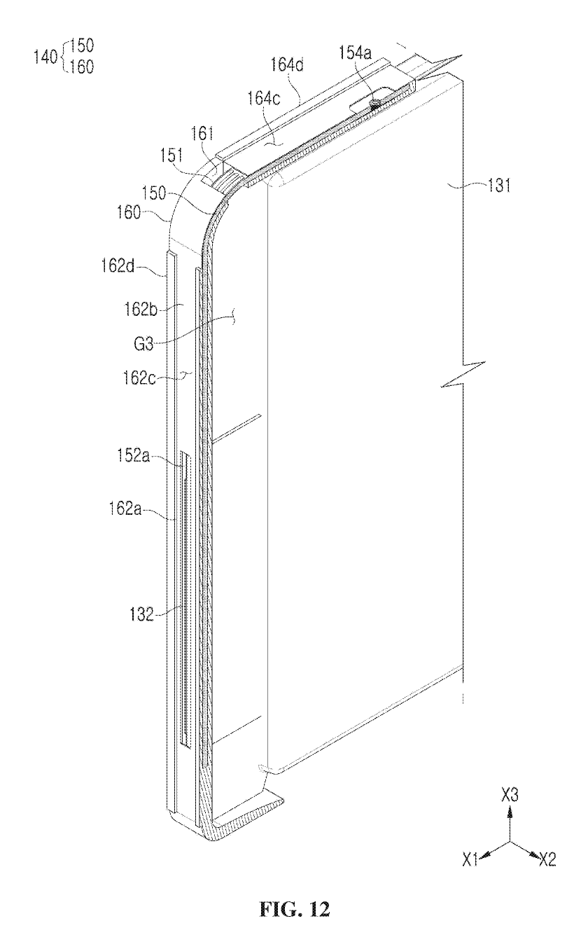

In some embodiments, the second access hole 164a may be provided to expose only an upper surface portion of the busbar 150. In other words, the second access hole 164a may be provided to pass through only an upper region of the third part 164, and a lower region of the third part 164 corresponding to the second access hole 164a may be provided in a closed form. In such a case, the upper surface portion of the busbar 150 may be exposed to the upper side through the second access hole 164a, whereas the corresponding lower surface portion of the busbar 150 may be provided in a structure blocked by the busbar molding 160 (see FIG. 12). In some cases, the busbar molding 160 may function to prevent the coupling member that is coupled to the terminal coupling hole 154a from being exposed to the lower portion of the busbar molding 160.

Similar to the first part 162 described above, in some embodiments, the third part 164 may be provided with an upper surface 164b disposed to face the inner surface 111 of the case 110. Specifically, the third part 164 may include the upper surface 164b as illustrated in FIG. 4, and the upper surface 164b may be disposed to face the inner surface 111 of the case 110 as illustrated in FIG. 5. Further, the upper surface 164b of the third part 164 may be spaced apart from the inner surface 111 of the case 110 by a predetermined gap. Accordingly, a second flow path 164c may be provided between the upper surface 164b of the third part 164 and the inner surface 111 of the case 110. The second flow path 164c may be formed to extend in the left-right direction between the upper surface 164b of the third part 164 and the inner surface 111 of the case 110, depending on the extended shape of the third part 164.

As described above, the second flow path 164c may function to guide the flow of gas discharged from the battery cell 130 toward the vent 123 (see FIG. 1) disposed in the cap plate 120. Specifically, when gas leaks from the region around the lead tab 132 of the battery cell 130, the leaked gas may flow through the opening 161 into the space between the busbar molding 160 and the inner surface 111 of the case 110, and the flowing gas may be guided to flow laterally (to the right) along the second flow path 164c between the inner surface 111 of the case 110 and the upper surface 164b of the third part 164.

In some embodiments, the upper surface 164b of the third part 164 may be provided with a second rib 164d. The second rib 164d may be provided to extend in the left-right direction along the upper surface 164b of the third part 164. In some embodiments, a plurality of second ribs 164d may be provided. For example, in the illustrated embodiment, two second ribs 164d are spaced apart in the front-rear direction with the second flow path 164c interposed therebetween. For reference, in the illustrated embodiment, the third part 164 does not have a lead tab 132 disposed thereon unlike the second part 163 described above, and thus the number and arrangement of the second ribs 164d may be provided differently from the number and arrangement of the lead tab 132.

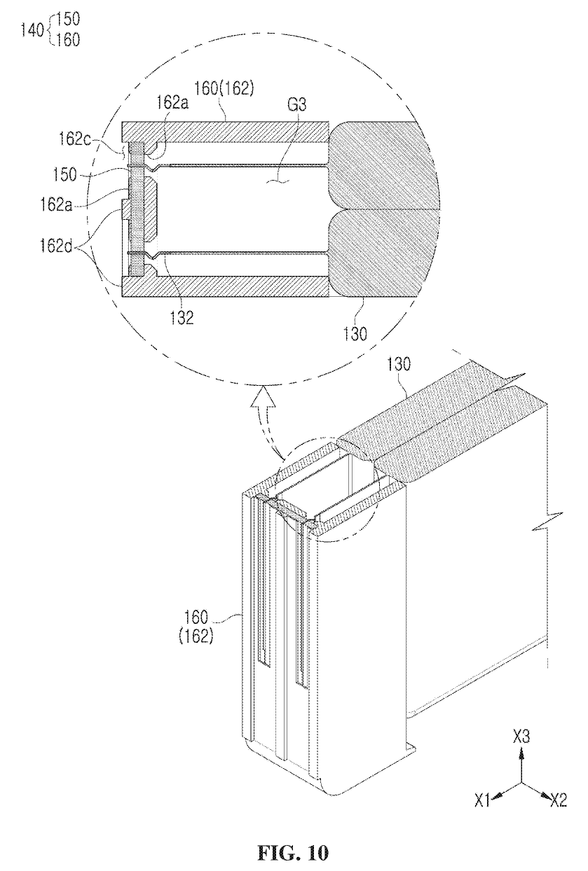

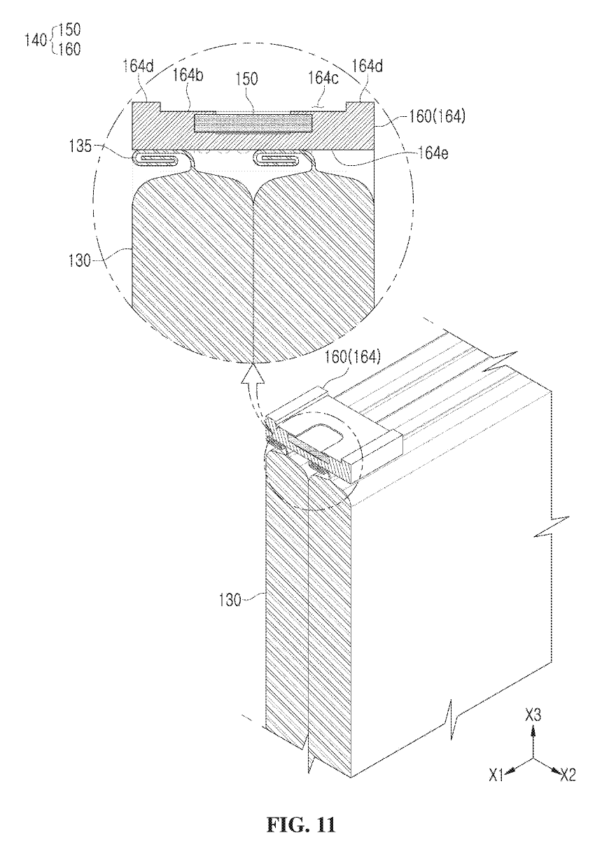

FIG. 10 is a cross-sectional view of the battery cell bundle illustrated in FIG. 3. FIG. 11 is a first longitudinal sectional view of the battery cell bundle illustrated in FIG. 3. FIG. 12 is a second longitudinal sectional view of the battery cell bundle illustrated in FIG. 3.

Referring to FIG. 10, in the illustrated embodiment, the busbar assembly 140 may be fastened to a side portion of the battery cell 130. The lead tab 132 of the battery cell 130 may be fastened to the busbar 150, and the end portion may be partially exposed through the first access hole 162a provided in the busbar molding 160. The first access hole 162a may form a passage connecting a space G3 inside the busbar assembly 140 and the first flow path 162c. Accordingly, gas discharged into the space G3 may be collected into the first flow path 162c through the first access hole 162a.

Referring to FIG. 11, in the illustrated embodiment, the folding portion 135 may be disposed at an upper end of the battery cell 130. As described above, the folding portion 135 may be provided to extend in the left-right direction along the upper end of the battery cell 130. Here, the folding portion 135 may be provided to be properly pressed by the busbar assembly 140. Specifically, the busbar molding 160 may be provided with a third part 164 extending in the left-right direction from an upper side of the folding portion 135, and the third part 164 may be disposed so that a lower surface 164e presses against the folding portion 135 to a predetermined extent. In other words, the folding portion 135 may be provided to be properly pressed by the lower surface 164e of the third part 164 to maintain its shape. The folding portion 135 and the third part 164 may function to limit the location where gas leaks from the battery cell 130. In other words, in the battery cell 130, leakage of gas from the region of the folding portion 135 may be relatively limited, and thus gas discharge may be induced in the region around the lead tab 132 described above.

Referring to FIG. 12, the busbar 150 may be provided to be embedded within the busbar molding 160. Accordingly, the busbar 150 may be properly electrically insulated from the remaining components except for some components that require electrical connection, such as the lead tab 132, the electrode terminal 121, and the like. The busbar 150 may be partially exposed through the opening 161 provided in the busbar molding 160. In other words, the notching portion 151 may be exposed to the outside of the busbar molding 160 through the opening 161. The opening 161 may provide a path for gas to flow between an inner region (a lower right region of the opening 161 in the drawing) of the busbar assembly 140 and an outer region (an upper left region of the opening 161 in the drawing) of the busbar assembly 140, and the gas flowing through the opening 161 may function to thermally damage the notching portion 151.

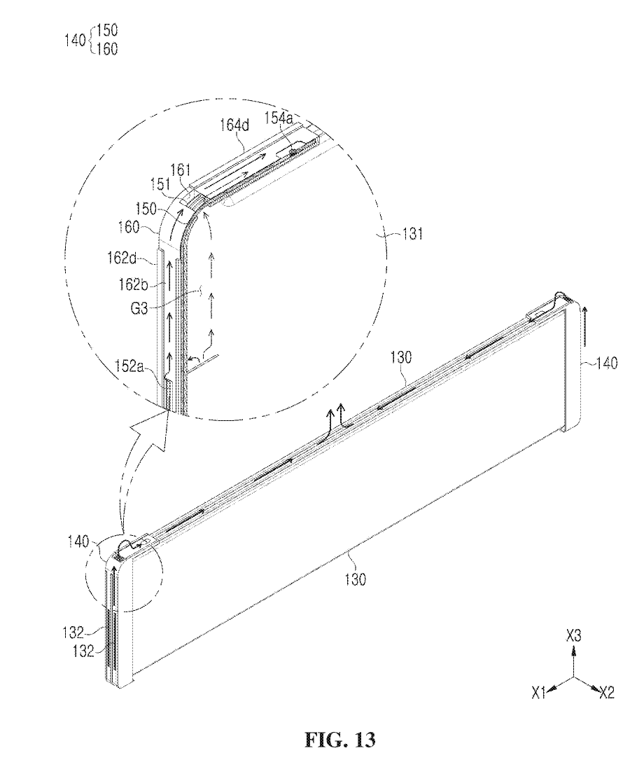

FIG. 13 is an operational view of the battery cell bundle illustrated in FIG. 1.

FIG. 13 illustrates, with reference to FIGS. 2 and 12, a path along which gas discharged from the region around the lead tab 132 moves. In some operational examples, when thermal runaway or the like occurs, high-temperature gases generated inside the battery cell 130 may rupture a sealing portion in the region around the lead tab 132 and may be discharged to the outside of the battery cell 130. In addition, the discharged gas may enter the space G3 between the busbar assembly 140 and the battery cell 130, and a portion of the discharged gas may flow toward the opening 161. Additionally, the gas flowing through the opening 161 may function to thermally damage the notching portion 151. Accordingly, the notching portion 151 may be melted, and the busbar 150 may be electrically disconnected. In other words, the notching portion 151 may be heated and melted by the discharged gas, thereby functioning to electrically disconnect the busbar 150.

Meanwhile, a portion of the gas discharged to the outside of the battery cell 130 may enter the first flow path 162c through the first access hole 162a. Further, the introduced gas may flow along the first flow path 162c, pass through the region in which the opening 161 is provided, and flow into the second flow path 164c. Subsequently, the gas may then flow along the second flow path 164c together with gas discharged through the opening 161, and may act on the vent 123, thereby functioning to cause the opening of the vent 123.

In some operational examples, a portion of the gas flowing along the first and second flow paths 162c and 164c may enter the opening 161 and may function to thermally damage the notching portion 151. Further, as described above, the gas flowing along the first and second flow paths 162c and 164c may interfere with gas flowing from the space G3 between the busbar assembly 140 and the battery cell 130 toward the opening 161, allowing the gas within the opening 161 to have sufficient contact time with the notching portion 151. Accordingly, the notching portion 151 may be more appropriately heated and melted, and electrical disconnection may be induced.

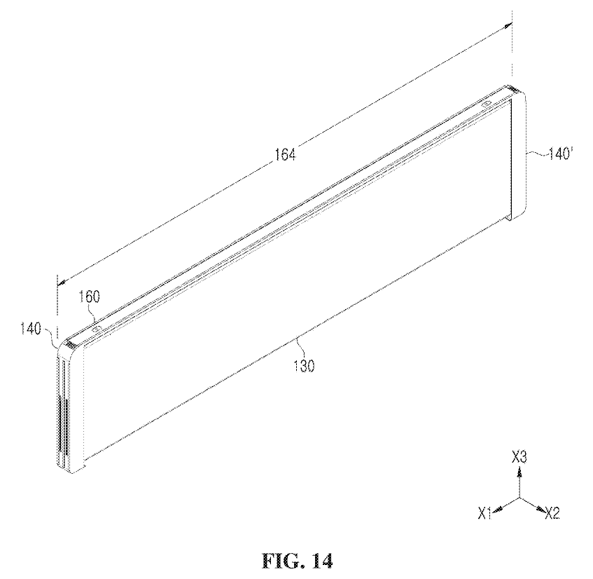

FIG. 14 is a perspective view illustrating a battery cell bundle according to another embodiment of the present disclosure.

Referring to FIG. 14, in some embodiments, each busbar assembly 140 and 140' disposed on the left and right sides of the battery cell 130 may be provided to be connected to each other side to side. For reference, FIG. 14 illustrates the bundle 100 with the case 110 and the cap plate 120 removed, as illustrated in FIG. 2 above. Specifically, the busbar molding 160 may be formed with the third part 164 extending in the left-right direction along the upper end of the battery cell 130, and the busbar assemblies 140 and 140' disposed on the left and right sides may be provided to be connected to each other through the extending busbar molding 160. In such a case, the busbar assemblies 140 and 140' on the left and right sides may be connected to each other and provided as substantially one assembled part.

As described above, some embodiments of the present disclosure may provide a battery cell bundle.

In addition, some embodiments of the present disclosure may provide a battery cell bundle in which electrical disconnection of the busbar may be induced by thermal damage. In some embodiments, the busbar may be provided with a notching portion exposed to the outside of the busbar molding, and the notching portion may be provided to interfere with gas flowing through the opening of the busbar molding, thereby being heated and melted. Accordingly, the busbar may be appropriately thermally damaged by the gas flowing inside the bundle, and electrical disconnection may be induced.

Further, in some embodiments of the present disclosure, a battery cell bundle may be provided in which the busbar may be properly electrically insulated inside the bundle. In some embodiments, the busbar may be insert-molded inside the busbar molding so that it is substantially not exposed to the outside, except for the notching portion, the fastening region of the lead tab, and the fastening region of the electrode terminal. Accordingly, more appropriate electrical insulation of the busbar inside the bundle may be implemented.

Further, some embodiments of the present disclosure may provide a battery cell bundle capable of appropriately inducing venting of pressure inside the bundle in response to a thermal runaway situation or the like. In some embodiments, the busbar molding may function to guide the flow of gas discharged from the battery cell through the first and second flow paths to the vent, such that the busbar molding may contribute to allowing pressure generated inside the bundle to act on the vent more quickly and effectively.

In addition, some embodiments of the present disclosure may provide a battery cell bundle that may improve safety of use. In some embodiments, disconnection of the busbar due to thermal damage as described above or induction of venting through the busbar molding may contribute to securing a safety means by the bundle itself in response to a thermal runaway situation, and such securing of a safety means by the bundle itself may contribute to improving safety of use in a battery cell bundle or a battery pack with which the battery cell bundle is combined.

The above description is merely an example of applying the principles of the present disclosure, and other configurations may be further comprised without departing from the scope of the present disclosure.

Some embodiments of the present disclosure can provide a battery cell bundle.

In addition, some embodiments of the present disclosure can provide a battery cell bundle in which electrical disconnection of a busbar may be induced by thermal damage.

Further, in some embodiments of the present disclosure, a battery cell bundle can be provided in which a busbar may be properly electrically insulated inside the bundle.

Further, some embodiments of the present disclosure can provide a battery cell bundle capable of properly inducing venting of pressure inside the bundle in response to a thermal runaway situation, or the like.

In addition, some embodiments of the present disclosure can provide a battery cell bundle that may improve safety of use.

What is claimed is:

1. A battery cell bundle comprising:
a battery cell provided with at least one lead tab; and
a busbar assembly fastened to the lead tab,
wherein the busbar assembly comprises:
a busbar having one region provided with a notching portion and electrically connected to the lead tab; and
a busbar molding accommodates the busbar therein and comprises an opening that exposes the notching portion.

2. The battery cell bundle of claim 1, further comprising a case that accommodates the battery cell and the busbar assembly therein,
wherein the battery cell comprises a pouch-type battery cell in which the lead tab is disposed on at least one end portion in a first direction.

3. The battery cell bundle of claim 1, wherein a plurality of battery cells are disposed in a second direction,
a gap is provided between sealing portions of a pair of battery cells adjacent in the second direction, and
at least a portion of the busbar is disposed at a position corresponding to the gap.

4. The battery cell bundle of claim 1, wherein the notching portion comprises at least one notching hole formed to pass through the busbar.

5. The battery cell bundle of claim 1, wherein the notching portion is provided as a region in which a cross-sectional area of the busbar is formed smaller than a cross-sectional area of an adjacent region.

6. The battery cell bundle of claim 1, wherein the notching portion is provided such that at least a portion thereof is melted by gas flowing through the opening to electrically disconnect the busbar.

7. The battery cell bundle of claim 1, wherein the busbar comprises:
a first part extending in a third direction and coupled to the lead tab;
a second part extending from one end of the first part and provided with the notching portion; and
a third part extending from one end of the second part in a first direction and electrically connected to an electrode terminal.

8. The battery cell bundle of claim 7, wherein the first part and the second part each have a width in a second direction, and
the width of the first part is provided such that at least a portion thereof gradually decreases toward the second part.

9. The battery cell bundle of claim 1, wherein the busbar is insert-molded inside the busbar molding.

10. The battery cell bundle of claim 1, wherein the busbar molding comprises:
a first part extending in a third direction and provided with a first access hole that exposes the lead tab;
a second part extending from one end of the first part and provided with the opening; and
a third part extending from one end of the second part in a first direction and provided with a second access hole that exposes a portion of the busbar for coupling of an electrode terminal.

11. The battery cell bundle of claim 1, wherein the busbar molding comprises a first part extending in a third direction and provided with a first surface disposed to face an inner surface of a case, and
the first surface provides a first flow path that guides the flow of gas in the third direction between the first surface and the inner surface.

12. The battery cell bundle of claim 11, wherein a first rib extending in the third direction is provided on the first surface.

13. The battery cell bundle of claim 1, wherein the busbar molding comprises a third part extending in a first direction and provided with a third surface disposed to face an inner surface of a case, and
the third surface provides a second flow path that guides the flow of gas in the first direction between the third surface and the inner surface.

14. The battery cell bundle of claim 13, wherein a second rib extending in the first direction is provided on the third surface.

15. The battery cell bundle of claim 1, wherein the battery cell comprises a folding portion extending in a first direction at one end in a third direction, and
the busbar molding comprises a third part extending in the first direction and pressing the folding portion.
